(19) United States
(12) Patent Application Publication
(10) Pub. No.: US 2020/0360220 A1
(43) Pub. Date: Nov. 19, 2020

(54) BACK EZE

(71) Applicant: Viktor Livshits, Denville, NJ (US)

(72) Inventor: Viktor Livshits, Denville, NJ (US)

(21) Appl. No.: 16/875,815

(22) Filed: May 15, 2020

Related U.S. Application Data
(60) Provisional application No. 62/849,533, filed on May 17, 2019.

(51) Int. Cl. A61H 1/02

(52) U.S. Cl. CPC A61H 1/0281; A61H 2201/0192; A61H 2201/0153; A61H 2201/1614

(57) ABSTRACT

A therapy device may include a hand grip and a shoulder support. The shoulder support is configured to abut a shoulder of the user while a hand of a user grips the hand grip. A length of the therapy device may then be adjusted to provide a stretch of the muscles of the user to provide relief from a number of ailments including back pain (both mid and upper back pain) and shoulder pain.

### CLAIM OF PRIORITY

This application claims priority to U.S. Application 62/849,533 filed on May 17, 2019, the contents of which are herein fully incorporated by reference in its entirety.

### FIELD OF THE EMBODIMENTS

The field of the present invention and its embodiments relate to a therapy device useful for managing back pain, particularly mid and upper back pain, and shoulder pain without the needs for medical intervention. In particular, the present invention and its embodiments relate to a lightweight, highly portable device that is utilized to passively stretch the back muscles of the user.

### BACKGROUND OF THE EMBODIMENTS

The present invention and its embodiments relate generally to the field of exercise and more specifically to an apparatus for stretching and strengthening muscles which can be used in a standing or seated position. Back muscle pain is one of the, if not the single most, common medical afflictions in the United States. Research has concluded that one of the best preventative measures to help prevent back muscle pain, is improving back muscle strength. Further, a lack of muscle flexibility contributes to numerous sports injuries annually. It is often very difficult to properly stretch tight muscles, because many people lack the ability to stretch sufficiently on their own. Accessibility to a quick, effective method of stretching muscles which can be utilized virtually anywhere, even on the job, is extremely limited.

This is precisely the reason a flexibility/rehabilitation device which is effective, easy to use, affordable and safe, will undoubtedly have a huge impact in personal health, and wellness not only in this country but worldwide. The need for a small, compact flexibility device which may be utilized while at work is also tremendous.

As stated previously, none of the known devices combines functionality with effectiveness. Either they are too cumbersome to make them usable daily, they require too much physical ability, and/or they are cost prohibitive.

For instance, U.S. Pat. No. 7,267,640 pertains to an apparatus for stretching and strengthening muscles from a standing or seated position with a support member having a top end and a bottom end, the top end providing a location for grasping, the bottom end providing a base surface for force distribution and support. A preferred embodiment includes the support member which is adjustable in length such that the distance between the top end and the bottom end is adjustable. A preferred embodiment includes a way for fixedly securing the adjustable support member at desired lengths.

U.S. Pat. No. 5,462,518 pertains to a multipurpose method and apparatus for: a) applying continuously variable suspension traction and decompressive forces to the spine to alleviate certain types of back pain, b) stretching, elasticizing, exercising, and strengthening, the muscles which affect an individual's spine, appearance, and posture, c) spinal manipulation and adjustment, and d) relieving pain and stress in the neck and shoulders. The apparatus, which does not restrict normal activities, utilizes spring loaded tube assemblies which are biased apart, and extend from, supports under each arm of the user to each side of an adjustable, multilayered belt adjacent the pelvis. Longitudinal adjustment of the tubes can vary the degree of traction while temporary variations can be accomplished by forcibly lowering the shoulders down into their normal position against the resistance of the compression springs. Exercising and stretching the muscles of the torso which affect the spine, posture and appearance, and to provide maximum suspension, decompression, and unloading can be accomplished by utilizing the removable handle attachments. The attachments extend from the support tubes just beneath the underarm supports and transfers the load from the underarms to the hands, arms, and shoulders.

U.S. Patent Application 2009/0187128 pertains to a shoulder-neck-shaper designed to alleviate the discomfort of upper back and neck in workers. Since the revolution of “IT” and “service industries” more and more of the workers sit at the desk hours and hours with neck bent and shoulder drooping forwards. Similarly, workers working over the counter tops have similar complaints. SNS unit will help in squaring the shoulders relieving the constant stretch of upper back of the top and inner connecting muscles of the shoulder blades. Similarly, a more natural position of the neck will help to relieve the discomfort at the junction of neck and upper thoracic spine. It may also relieve any pins and needles in arms by opening numeral foramina of the neck bones by relieving any stretched nerves of neck and upper back.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention and its embodiments relate to a therapy/rehabilitation device configured to stretch a muscle or groups of muscles of a user. Generally, the user will support the device against a portion of their chest/shoulder area and grip the device with their hand in the grip section of the device. The user can then extend the “legs” of the device while continuing to grip the device to provide a targeted therapy/exercise to a specific muscle group. The therapy device can be used as necessary or as recommended by a doctor, rehabilitation therapist, etc.

In at least one embodiment there is a therapy device having a shoulder support; a first length; a second length; and a grip.

In another embodiment of the present invention there is a therapy device having a shoulder support having a first side and a second side; a first length having a first end and a second end, the first length being coupled to the second side of the shoulder support; a second length having a first end and a second end, the second length being slidably engaged to the first length; an adjustment mechanism configured to extend or retract the second length along the first length; and a grip coupled to the second end of the second length.

In yet another embodiment of the present invention there is a therapy device having a shoulder support having a first side and a second side; a first length comprising a first support and a second support, the first support and the second support being coupled to the second side of the shoulder support; a second length comprising a first support and a second support, the second length being slidably engaged to the first support and the second support of the first length; an adjustment mechanism configured to extend or retract the second length along the first length, wherein a lever of the adjustment mechanism causes the second length to extend along the first length; a support mechanism coupled to the adjustment mechanism to position the adjustment mechanism between first support and the second support; and a grip coupled to the second end of the second length.

It is an object of the present invention to provide a therapy device that is lightweight and portable.

It is an object of the present invention to provide a therapy device that is easy to use.

It is an object of the present invention to provide a therapy device that is inexpensive.

It is an object of the present invention to provide a therapy device that can be used for rehabilitation purposes.

It is an object of the present invention to provide a therapy device that can be used for muscle strengthening and flexibility exercises.

It is an object of the present invention to provide a therapy device addresses the root cause of shoulder/back pain that plagues numerous individuals in today's society.

### BRIEF DESCRIPTION OF THE DRAWINGS

FIG. 1A shows a perspective view of a first embodiment of the present invention in a retracted position.

FIG. 1B shows a perspective view of first embodiment of the present invention in an extended position.

FIG. 2A shows a side view of a first embodiment of the present invention in a retracted position.

FIG. 2B shows a side view of first embodiment of the present invention in an extended position.

FIG. 3A shows a back view of a first embodiment of the present invention in a retracted position.

FIG. 3B shows a back view of first embodiment of the present invention in an extended position.

FIG. 4 shows an exploded parts view of a first embodiment of the present invention.

FIG. 5A shows a perspective view of a second embodiment of the present invention in a retracted position.

FIG. 5B shows a perspective view of second embodiment of the present invention in an extended position.

FIG. 6A shows a side view of a second embodiment of the present invention in a retracted position.

FIG. 6B shows a side view of second embodiment of the present invention in an extended position.

FIG. 7 shows an exploded parts view of a second embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

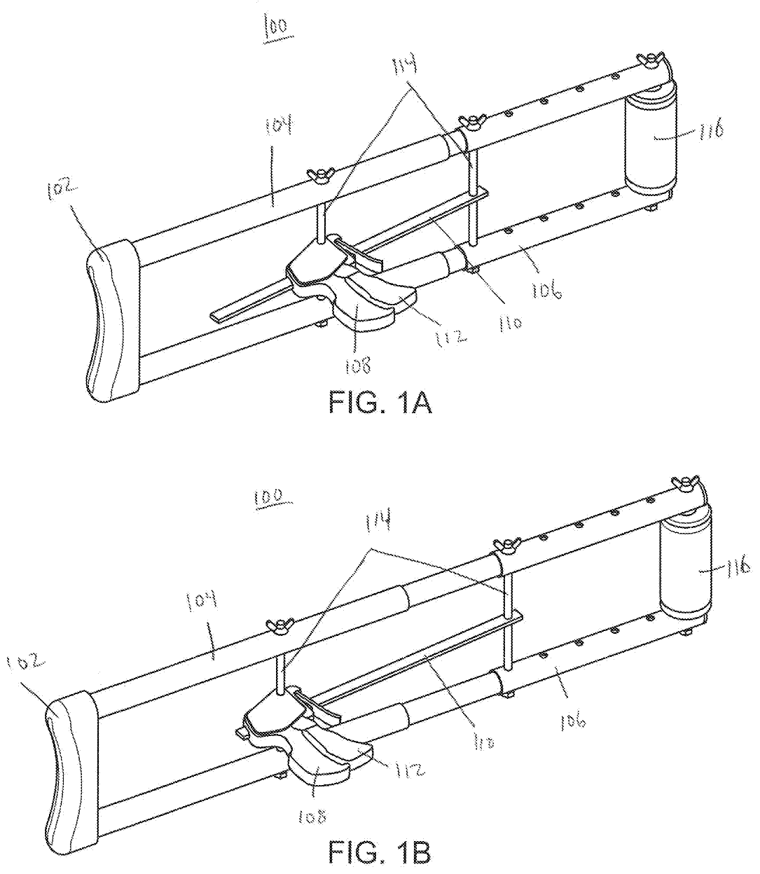

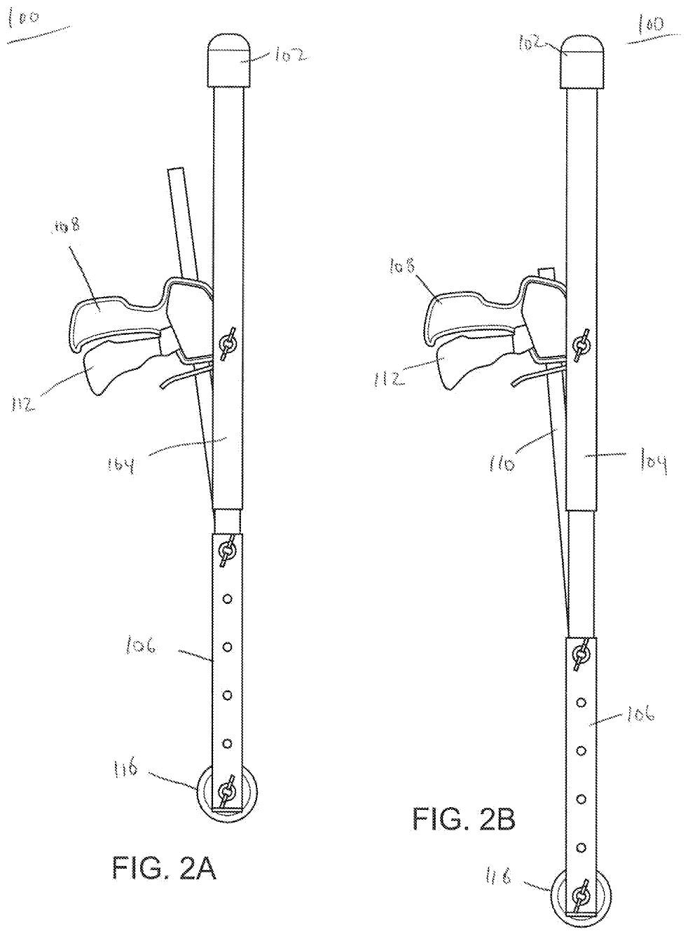

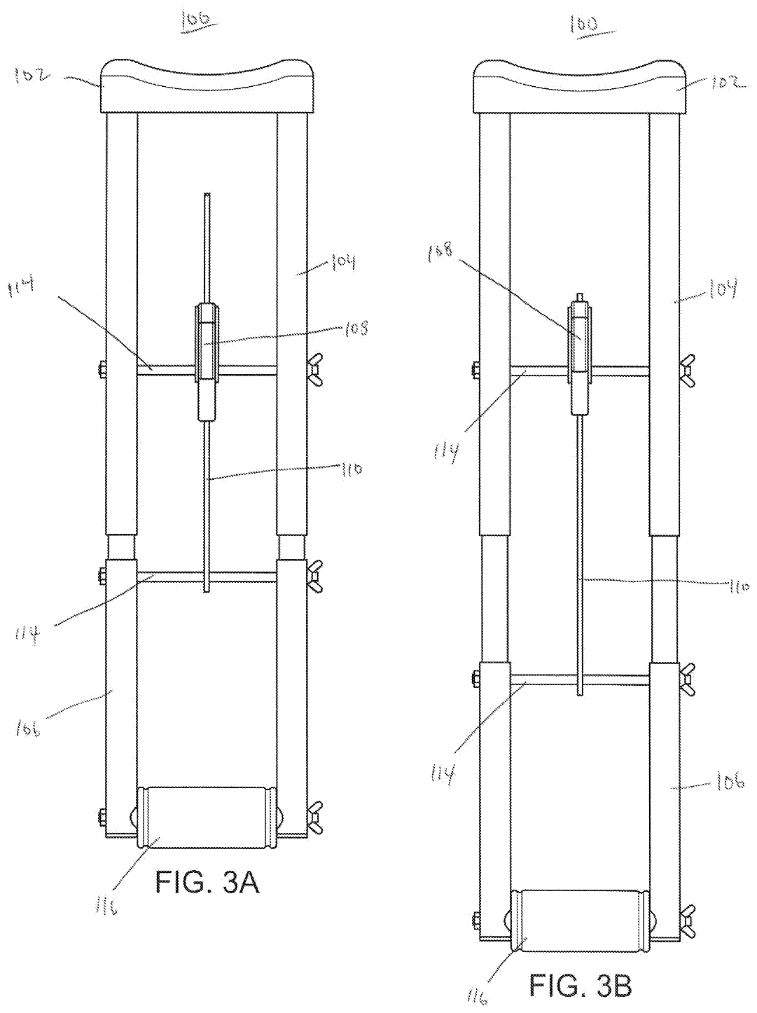

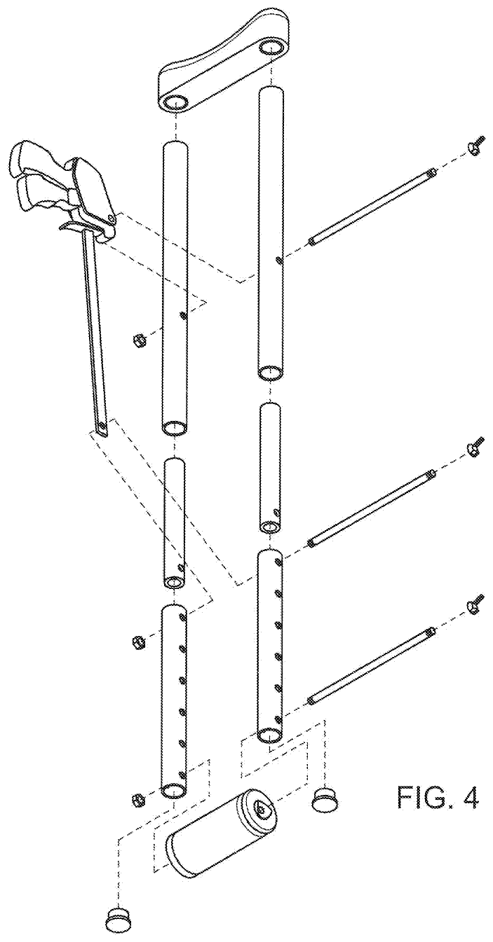

Referring now to FIGS. 1A-4, there is generally a therapy device 100, shoulder support 102, a first length 104, a second length 106, an adjustment mechanism 108, a grip 116, trigger, 112, supports 114, and extender 110. The therapy device 100 is configured to provide various outlets for stretching of musculature of the user as well as treating mid and upper back pain as well as shoulder pain.

The therapy device 100 is configured such that the shoulder support 102 is configured to abut a shoulder of a user. The shoulder support 102, generally comprises a foundation of a resilient material (e.g. metals, plastics, composites, etc.) with a layer of padding disposed thereover. The padding may be removable or may be affixed permanently to the underlying foundational structure.

Attached to a second side, or underside, of the shoulder support 102 is the first length 104. The first length 104 may comprise two “legs” or extensions of material that are affixed by a securement mechanism to the shoulder support 102. The first length 104 is generally a hollow tubular member that is comprised of the same or a different material as the foundation of the shoulder support 102. The first length 104 may have apertures through which supports 114 can be coupled to provide support for the adjustment mechanism 108.

Further, the first length 104 is configured to be slidably coupled to the second length 106. In one embodiment, the first length 104 is configured to receive the second length 106 therein. In yet other embodiments, the second length 106 is configured to receive the first length 104. The second length 106 is substantially similar in nature to the first length 104. The second length 106 also has a plurality of apertures to receive a support 114 therethrough. The support 114 coupled to the second length 106 is configured to couple to the extender 110. At a distal end of the second length 106, is a grip 116.

The grip 116 may be comprised of a support mechanism that is coupled to the second length 106 via at least one and preferably two apertures in the second length 106. A securement mechanism is utilized to secure a position of the grip 116 along the length of the second length 106. The grip 116 further has a padding that envelops most of the support mechanism of the grip 116. The padding provides comfort as well as a gripping surface for which the user grips or holds with their hand when utilizing the device.

The adjustment mechanism 108 generally comprises a trigger 112 and an extender 110. The trigger 112 may be actuated thereby causing the extender 110 to extend. The net result being that the overall length of the device 100 is modified to support a user's needs when utilizing the device for therapy or stretching purposes. In some embodiments, there is a locking mechanism that secures a position of the extender 110 with each pull of the trigger 112, This allows a position of the extender 110 to remain fixed and to set the device 100 at a desired length for use. In such an embodiment, a release mechanism may be utilized to allow the device 100 to “collapse” and return the extender to a retracted state.

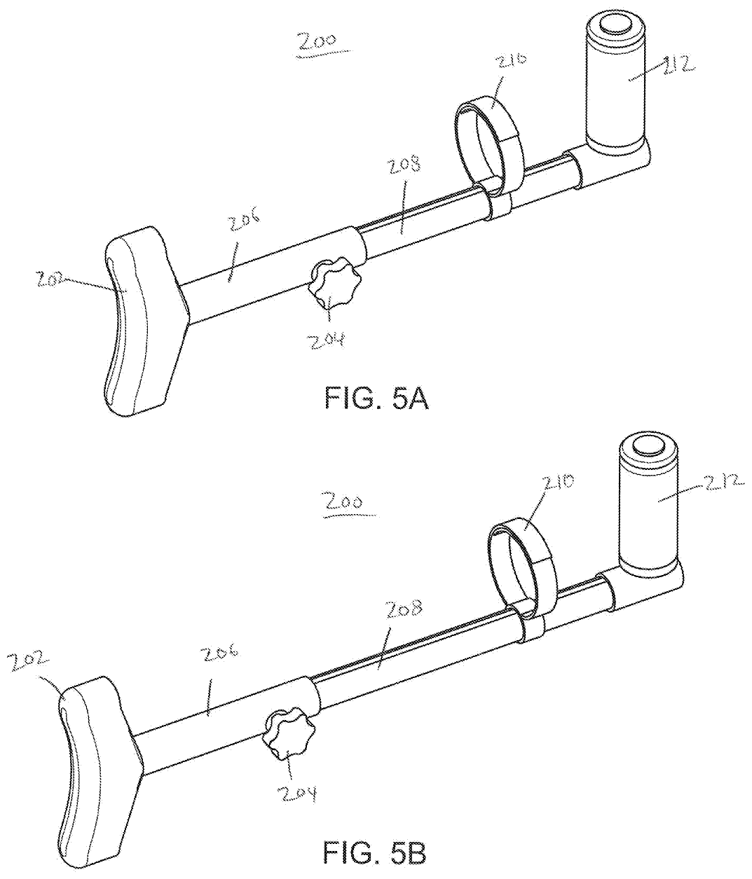

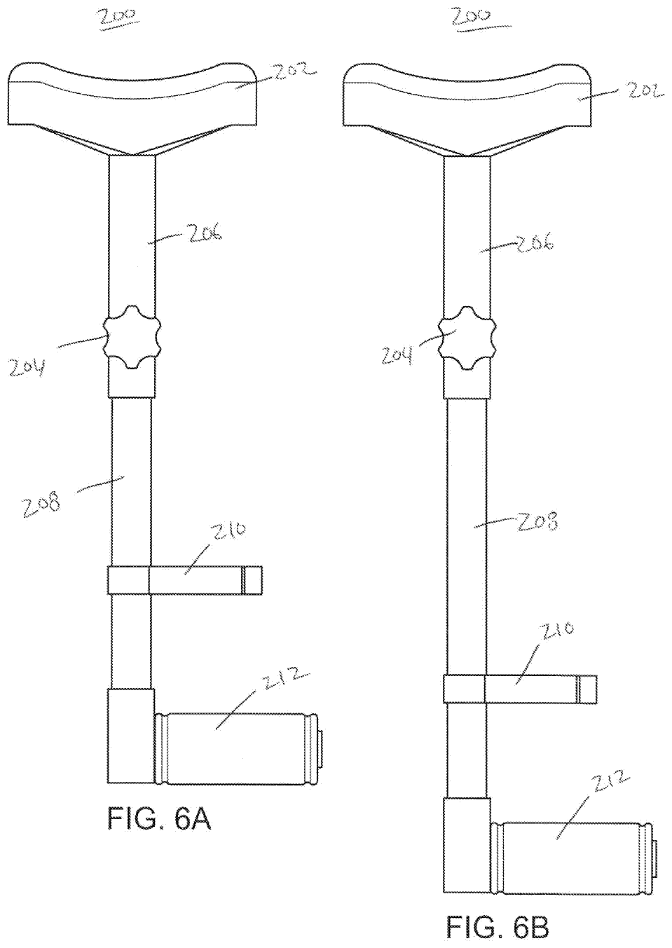

Yet another embodiment is shown in FIGS. 5-7. Here, there is a therapy device 200 having a shoulder support 202, a first length 206, a second length 208, an adjustment mechanism 204, a securement mechanism 210, and a grip 212.

The shoulder support 202 is attached to a first length 206 which is slidably engaged to a second length 208. The adjustment mechanism 204 may be a rotational mechanism or rotary mechanism. That is, that rotation of the adjustment mechanism 204 causes a lengthening of the therapy 200 by causing the second length 208 to extend from the first length 204. The adjustment mechanism 204 may further have a locking mechanism that prevents the second length 208 from being retracted without first disengaging the locking mechanism.

In at least one embodiment, the first length 206 and the second length 208 have a tongue and groove feature that allows the two lengths to slidably engage with one another. This tongue and groove feature further prevents angular rotation of the second length 208 relative to the first length 206.

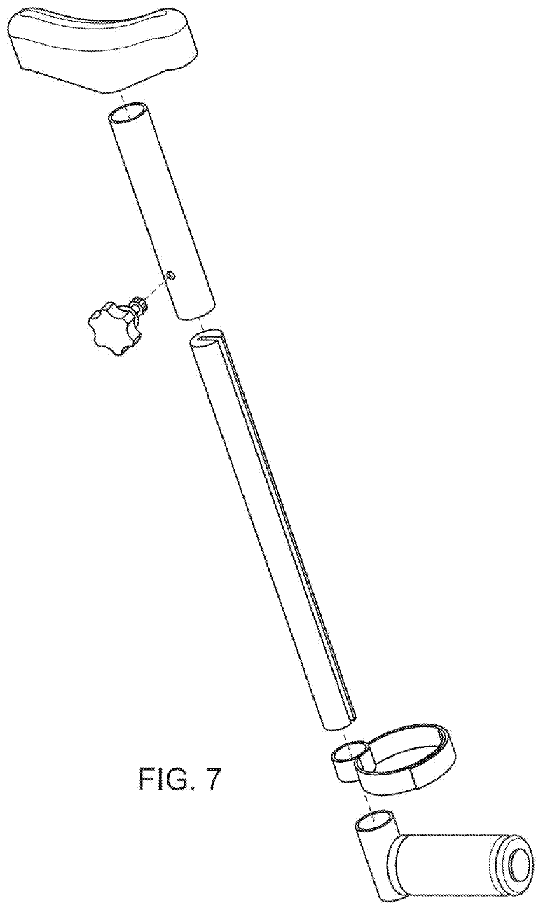

The securement mechanism 210 may take the form of a cuff that has a mechanism thereon to allow for a size adjustment of the cuff. Such a mechanism may be a latch, clasp, hook and loop fastener or the like or some combination thereof. A position of the securement mechanism 210 is preferably at a fixed point along a length of the second length 208. However, the securement mechanism 210 may be repositionable along different intervals of the second length 208. In some embodiments, the securement mechanism 210 comprises a loop that is sized to accommodate the second length 208 thereby allowing the securement mechanism 210 to be coupled to the second length 208 (see FIG. 7).

The grip 212 may be comprised of a support mechanism that is coupled to the second length 208. A securement mechanism is utilized to secure a position of the grip 212 along the length of the second length 208. The grip 212 further has a padding that envelops most of the support mechanism of the grip 212. The padding provides comfort as well as a gripping surface for which the user grips or holds with their hand when utilizing the device. In other embodiments, the grip 212 has a recess configured to receive an end of the second length 208 thereby coupling the grip 212 to the second length 208.

In use, a user would position the embodiment of the present invention up against a front of the shoulder of the user. The shoulder support is configured to abut this area of the user. The user may then secure the corresponding arm to the device or simply place their hand in a firm yet comfortable position around the grip. The device may then be manipulated, via the adjustment mechanism, to adjust a length of the device. As the length is adjusted, the user is to continually leave the device abutting their shoulder and maintain their grip around the grip portion of the device. This, in turn, causes the desired stretching of the back and/or should muscles. Once the stretching is completed, the user can retract the device and remove themselves from the device.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A therapy device comprising:
a shoulder support;
a first length;
a second length; and
a grip.

2. The therapy device of claim 1 further comprising:
an adjustment mechanism.

3. The therapy device of claim 1 further comprising a cuff.

4. The therapy device of claim 1 wherein the first length is slidably engaged with the second length.

5. The therapy device of claim 2 wherein the adjustment mechanism is rotatably coupled to either the first length or the second length.

6. The therapy device of claim 5 wherein rotation of the adjustment mechanism modifies a relationship between the first length and the second length.

7. The therapy device of claim 2 wherein the adjustment mechanism is coupled to each of the first length and the second length.

8. The therapy device of claim 7 wherein the adjustment mechanism comprises at least one lever.

9. The therapy device of claim 8 wherein the at least one lever is configured to modify a relationship between the first length and the second length.

10. A therapy device comprising:
a shoulder support having a first side and a second side;
a first length having a first end and a second end, the first length being coupled to the second side of the shoulder support;
a second length having a first end and a second end, the second length being slidably engaged to the first length;
an adjustment mechanism configured to extend or retract the second length along the first length; and
a grip coupled to the second end of the second length.

11. A therapy device comprising:
a shoulder support having a first side and a second side;
a first length comprising a first support and a second support, the first support and the second support being coupled to the second side of the shoulder support;
a second length comprising a first support and a second support, the second length being slidably engaged to the first support and the second support of the first length;
an adjustment mechanism configured to extend or retract the second length along the first length,
wherein a lever of the adjustment mechanism causes the second length to extend along the first length;
a support mechanism coupled to the adjustment mechanism to position the adjustment mechanism between first support and the second support; and
a grip coupled to the second end of the second length.
